(19) United States
(12) Patent Application Publication
(10) Pub. No.: US 2015/0290791 A1
(43) Pub. Date: Oct. 15, 2015

(54) ELECTRIC TOOLS

(71) Applicant: MAKITA CORPORATION, Anjo-shi (JP)

(72) Inventors: Koji TAKAHASHI, Anjo-shi (JP); Yuji SAKAKIBARA, Anjo-shi (JP)

(21) Appl. No.: 14/678,466

(22) Filed: Apr. 3, 2015

(30) Foreign Application Priority Data
Apr. 10, 2014 (JP) 2014-081030

(51) Int. Cl. B25F 5/02; B25F 5/00

(52) U.S. Cl. CPC B25F 5/02; B25F 5/008

(57) ABSTRACT

An electric tool may include a drive main body configured to accommodating an electric motor. A handle may extend downwards from a lower portion of the chive main body. A middle finger positioning portion may be disposed at an outer peripheral surface of the drive main body and includes a recessed structure to allow positioning of a middle finger of a hand of a user when the user grasps the drive main body in a body grasping mode, in which the drive main body is held between a thumb and an index finger of the hand from behind.

### CROSS-REFERENCE TO RELATED APPLICATIONS

This application claims priority to Japanese patent application serial number 2014-081030, the contents of which are incorporated herein by reference.

### TECHNICAL FIELD

Embodiments of the present disclosure relate to electric tools such as electric screwdrivers and electric hammer drills.

### BACKGROUND ART

Known electric tools may include a drive main body accommodating a motor and generating a drive force, and a handle grasped by a hand of a user. The drive main body and the handle may be arranged with respect to each other in an inverted L-shape in a side view. Mores specifically, the drive main body and the handle of the electric tool may be arranged so as to allow the electric tool to be handled like a pistol (see, for example, Japanese Patent Publication No. H03-50675 (also published as Japanese Laid-Open Patent Publication No. S62-120986)).

On the one hand, regarding the mode of use of the electric tool, there is known a mode of use in which the electric tool is grasped so as to apply a force thereto in a direction along the rotational axis of the output shaft. In this mode of use, the drive main body may be grasped from behind so as to be held between the thumb and the index finger, and a force is applied so as to press the rear end of the drive main body against a workpiece while the drive main body is held between the thumb and the index finger. In this state, a part between the thumb and the index finger of the grasping hand may be positioned on the rotation axis of the output shaft. In this way, it is possible to apply a force to the electric tool in the direction along the rotational axis of the output shaft by the grasping hand.

There has been a need in the art for techniques of enabling electric tools to be firmly grasped, for example, when the electric tools are pulled back after being pressed against workpieces.

### SUMMARY

In one aspect according to the present disclosure, an electric tool may include a drive main body configured to accommodating an electric motor that generates a drive force, an output portion disposed on a front side of the drive main body and configured to output the drive force, a handle extending downwards from a lower portion of the drive main body, and a middle finger positioning portion disposed at an outer peripheral surface of the drive main body. The middle finger positioning portion may be recessed to allow positioning of a middle finger of a hand of a user when the user grasps the drive main body in a body grasping mode, in which the drive main body is held between a thumb and an index finger of the hand from behind.

With this arrangement, due to the recessed structure of the middle finger positioning portion, it may be possible to achieve an improvement in finger engaging ability for the middle finger when the middle finger is positioned at the middle finger positioning portion. As a result, the electric tool can be firmly grasped with the hand, for example, when the user pulls back the electric tool after stopping the pressing of the electric tool against a workpiece.

The electric tool may further include an index finger positioning portion disposed at the outer peripheral surface of the drive main body and includes a recessed structure to allow positioning of the index finger when the user grasps the drive main body in the body grasping mode. With this arrangement, due to the recessed structure of the index finger positioning portion, it may be possible to achieve an improvement in finger engaging ability for the index finger when the middle finger is positioned at the index finger positioning portion. As a result, it is possible to further firmly grasp the electric tool with the grasping hand, for example, when the user pulls back the electric tool after stopping the pressing of the electric tool against a workpiece.

The electric tool may further include an auxiliary finger positioning portion disposed at the outer peripheral surface of the drive main body and includes a recessed structure to allow positioning of the middle finger or a ring finger of the hand when the user grasps the drive main body in the body grasping mode. With this arrangement, due to the recessed structure of the auxiliary finger positioning portion, it may be possible to achieve an improvement in finger engaging ability for the middle finger or the ring finger when the middle finger or the ring finger is positioned at the auxiliary finger positioning portion. As a result, it is possible to further firmly grasp the electric tool with the grasping hand, for example, when the user pulls back the electric tool after stopping the pressing of the electric tool against a workpiece.

The drive main body includes a body housing having the outer peripheral surface. At least one inlet opening and at least one outlet opening may be formed in the body housing and configured to allow communication between inside and outside of the body housing, so that air can flow into the body housing via the at least one outlet opening and can flow to the outside via the at least one outlet opening. The at least one inlet opening and the at least one outlet opening may be disposed at a lower portion of the body housing. In general, it may be preferable that the fingers of the user do not contact the region where the inlet opening(s) and the outlet opening(s) are disposed. Therefor, by disposing the inlet opening(s) and the outlet opening(s) at the lower portion of the body housing, it may be possible to use a relatively large area of the outer circumferential surface of the body housing for the middle finger positioning portion. Thus, it is possible to enhance the ease of handling of the electric tool and to improve the design of the electric tool.

The middle finger positioning portion may be disposed on a front side of both of the at least one inlet opening and the at least one outlet opening. Therefore, it may be possible to appropriately position the middle finger positioning portion while securing the communication of air through the inlet opening(s) and the outlet opening(s). As a result, it is possible to appropriately position the middle finger positioning portion without adversely affect the function of the electric tool.

The auxiliary finger positioning portion may be disposed between the at least one inlet opening and the at least one outlet opening. With this arrangement, it may be possible to appropriately position the auxiliary finger positioning portion while securing the communication of air through the inlet opening(s) and the outlet opening(s). As a result, it is possible to appropriately position the auxiliary finger positioning portion for allowing positioning of the middle finger or the ring finger without adversely affect the function of the electric tool.

The electric tool may further include a trigger lever disposed at the handle and arranged such that the user can pull the trigger lever by at least a little finger of the hand when the user grasps the drive main body in the body grasping mode.

The electric tool may further include a little finger engaging structure disposed at the handle and includes a recessed structure to allow positioning of at least a little finger of the hand when the user grasps the handle in a handle grasping mode in which the handle is held between the thumb and the index finger of the hand from behind.

In another aspect according to the present disclosure, an electric tool may include a drive main body configured to accommodating an electric motor that generates a drive force, an output portion disposed on a front side of the drive main body and configured to output the drive force, a handle extending downwards from a lower portion of the drive main body, a first hand-grip structure disposed at an outer peripheral surface of the drive main body, a second hand-grip structure disposed at an outer peripheral surface of the handle, and a trigger lever disposed at the handle. The first and second hand-grip structures and the trigger lever may be arranged such that (a) when a user grasps the drive main body in a body grasping mode in which the drive main body is held between a thumb and an index finger of the hand from behind, the index finger and a middle finger of the hand engage the first hand-grip structure, while at least one of a ring finger and a little finger of the hand being engaged with the trigger lever, and (b) when the user grasps the handle in a handle grasping mode in which the handle is held between the thumb and the index finger of the hand from behind, the little finger engages the second hand-grip structure while the middle finger being engaged with the trigger lever.

In a further aspect according to the present disclosure, an electric tool may include a drive main body configured to accommodating an electric motor, an output portion disposed on a front side of the drive main body and configured to be driven by the electric motor, and a handle extending downwards from a lower portion of the drive main body. A left side elastomer member and a right side elastomer member may be respectively disposed at a left side portion and a right side portion of an outer peripheral surface of the drive main body and extending in a front-rear direction. A step portion may be disposed at the outer peripheral surface of the chive main body at a position on the lower side of at least one of the left side and right side elastomer members.

### BRIEF DESCRIPTION OF THE DRAWINGS

FIG. 1 is an external side view of an electric screwdriver according to a representative embodiment;

FIG. 2 is a vertical sectional view illustrating the internal structure of the electric screwdriver;

FIG. 3 is a sectional view taken along line (III)-(III) in FIG. 2;

FIG. 4 is a sectional view taken along line (IV)-(IV) in FIG. 1;

FIG. 5 is a sectional view taken along line (V)-(V) in FIG. 1;

FIG. 6 is a sectional view taken along line (VI)-(VI) in FIG. 1;

FIG. 7 is a sectional view taken along line (VII)-(VII) in FIG. 1;

FIG. 8 is a sectional view schematically illustrating the internal structure of a controller of the electric screwdriver;

FIG. 9 is a side view schematically illustrating a first grasping mode for grasping the electric screwdriver by a band of a user;

FIG. 10 is a side view schematically illustrating a second grasping mode;

FIG. 11 is a side view schematically illustrating a third grasping mode;

FIG. 12 is a side view schematically illustrating a fourth grasping mode;

FIG. 13 is a side view schematically illustrating a fifth grasping mode; and

FIG. 14 is a side view schematically illustrating a sixth grasping mode.

### DETAILED DESCRIPTION

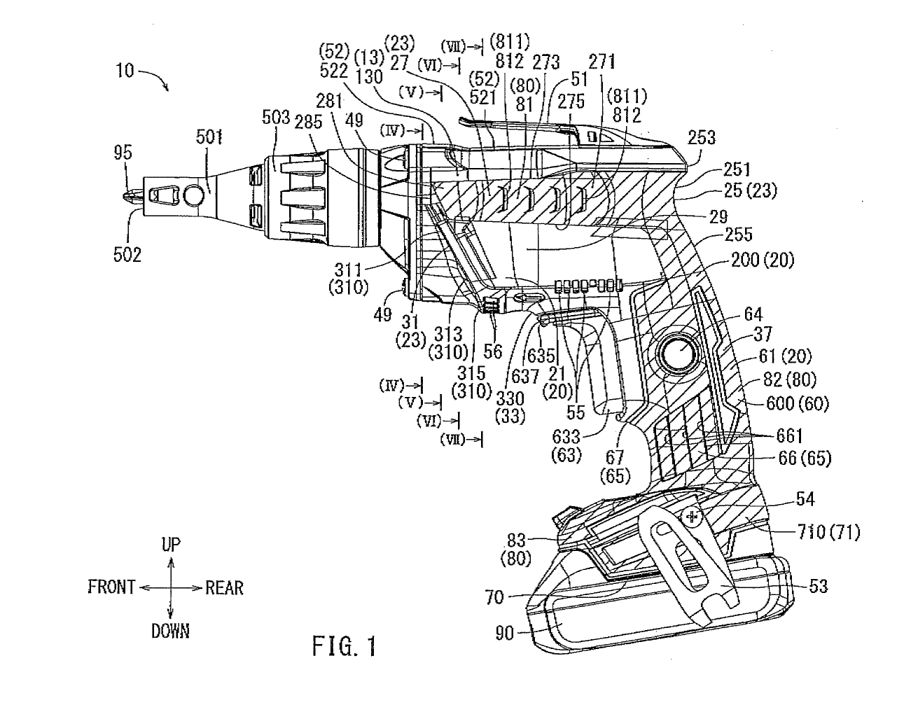

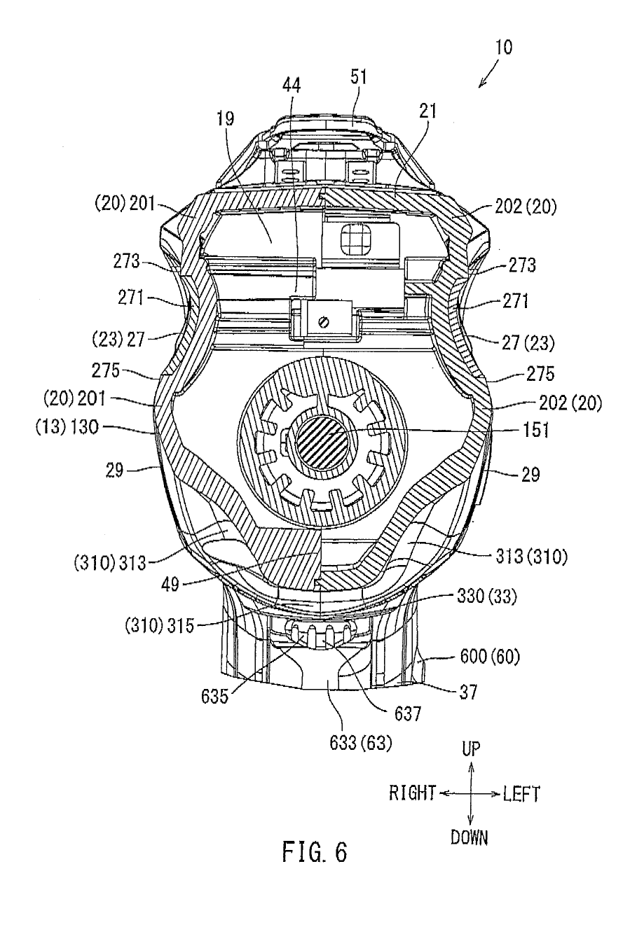

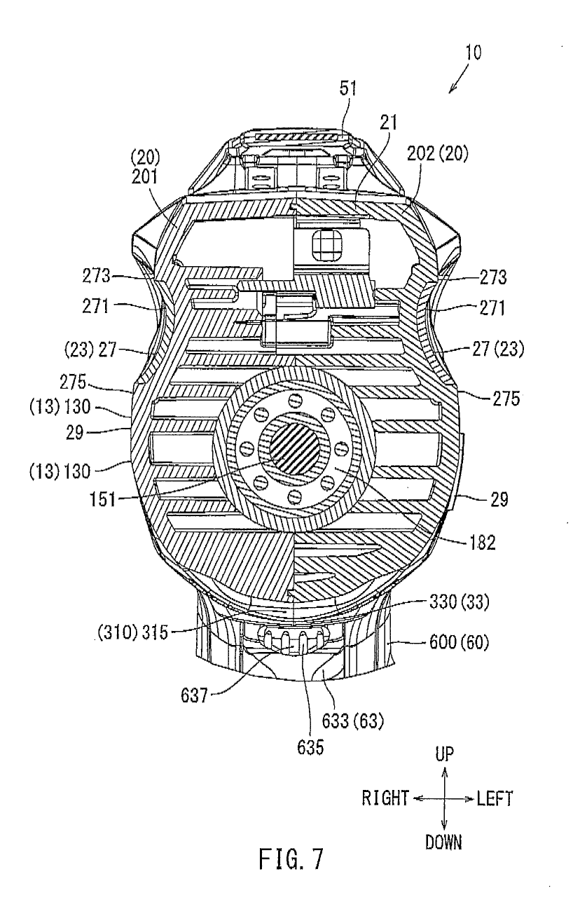

A representative embodiment will now be described with reference to the drawings. FIGS. 1 through 7 show an electric screwdriver 10 as an example of an electric tool. For the sake of convenience in illustration, the front, rear, upper, lower, left, and right sides of the electric screwdriver 10 will be determined as indicated in the drawings. More specifically, the output side of the electric screwdriver 10 is determined as the front side of the electric screwdriver 10 (tool front side), and the side opposite the same is determined as the rear side of the electric screwdriver 10. Further, the battery attachment side is determined as the lower side (tool lower side) of the electric screwdriver 10, and the opposite side is determined as the upper side of the electric screwdriver 10. The left-right direction of the electric screwdriver 10 is determined based on the front, rear, upper, and lower sides.

The electric screwdriver 10 shown in FIG. 1 may be used for driving screws (e.g., male screws) into workpieces. A rechargeable battery 90 may be attached to the electric screwdriver 10 and may serve as a power source. The electric screwdriver 10 may generally include a drive main body 13, an output portion 40, a handle 60, and a battery attachment portion 70. The drive main body 13 may include a motor housing 21 that is a part of a housing 20 and accommodates an electric motor 14. The motor housing 21 may serve as a main body housing. The electric motor 14 may be a brushless DC motor.

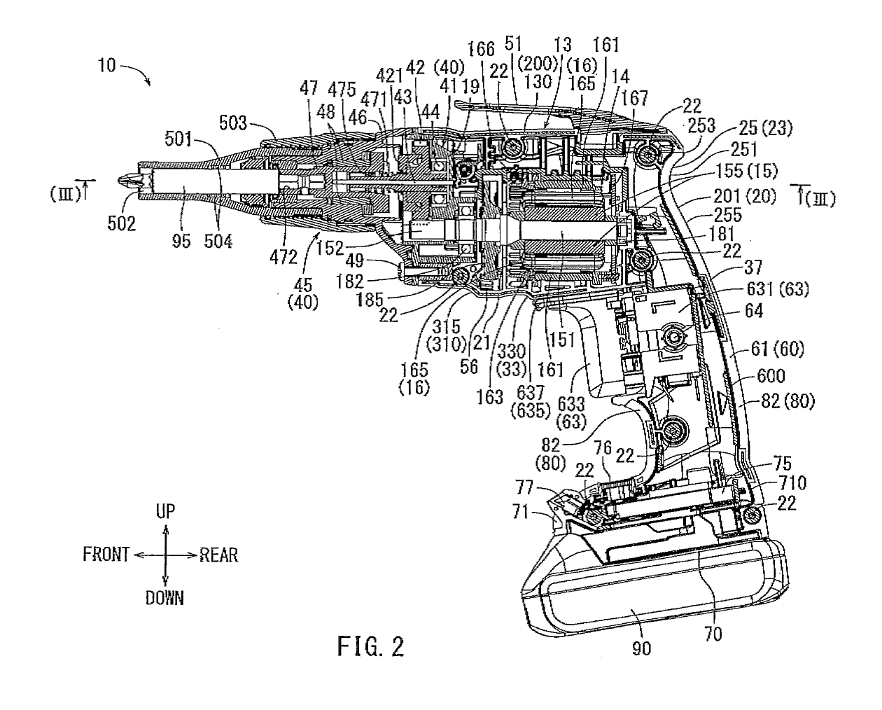

The housing 20 may includes the motor housing 21 accommodating the electric motor 14 and may also include a handle housing 61 of handle 60, and a lower enlarged portion 71 forming a battery attachment portion 70. The housing 20 may be formed by joining housing halves each formed of a molded resin. More specifically, the housing may be formed by joining a right housing 201 and a left housing 202 together by screws (not shown). For this purpose, as shown in FIG. 2, the right housing 201 may be provided with seven bosses 22 for fastening the screws.

The electric motor 14 may include a rotor 15 and a stator 16. A motor shaft 151 may be rotatably supported by the housing 20 via bearings 181 and 182. More specifically, the rear end of the motor shaft 151 may be rotatably supported via the rear bearing 181 that is mounted to the motor housing 21 (housing 20). Further, the front side portion of the motor shaft 151 may be rotatably supported by the front side bearing 182 that is mounted to the motor housing 21 (housing 20). The front side bearing 182 may be mounted to by the housing 20 via a bearing retainer 19. The bearings 181 and 182 may be ball bearings. A rotor core 155 may be mounted to the periphery of the motor shaft 151.

The stator 16 may generally include a stator core 161, an insulator 163, a coil 165, and a sensor circuit board 167. The stator core 161 may be arranged in the circumferential direction around the outer peripheral side of the motor shaft 151. The stator core 161 may be supported by the motor housing 21. The insulator 163 may be disposed around the stator core 161. The coils 165 may be disposed on the inner side of the stator core 161. The coils 165 may be supplied with electric power from a controller 75 via a power line 166. The coils 165 supplied with electric power may generate magnetic fields that may act on four magnets (not shown). The sensor circuit board 167 may be disposed on the rear side of the coils 165. The sensor circuit board 167 may include three Hall ICs. That is, in generating magnetic fields by the coils 165, the sensor circuit board 167 may detect the relationship between the magnets and the coils 165, and may transmit detection signals to the controller 75. The rear side bearing 181 may be disposed on the rear side of the sensor circuit board 167 for supporting the motor shaft 151.

By using a brushless DC motor as the electric motor 14, the electric motor 14 may be less bulky as compared with a brushed motor. More specifically, the length in the axial direction (front-rear direction) of the motor shaft 151 of this electric motor 14 may be shorter than the brushed motor. Further, the length in the radial direction (the left-right, up-down direction in the drawings) of the motor shaft 151 of this electric motor 14 may be also shorter than that of the brushed motor.

A cooling fan 185 may be mounted to the front side portion of the motor shaft 151 at a position on the rear side of a portion of the motor shaft 151 where the motor shaft 151 is supported by the front side bearing 182. The cooling fan 185 may be a centrifugal fan and may serve to mainly cool the heat of the electric motor 14, which may be generated at the coils 165. The cooling fan 185 may draw air from the rear side in the rotational axis direction of the motor 151, and may discharge the air toward the radially outer centrifugal side of the motor shaft 151. More specifically, as the cooling fan 185 rotates, external air may be drawn into the interior of the motor housing 21 from inlet openings 55 provided in the motor housing 21 as will be described later.

Further, as the cooling fan 185 rotates, the internal air of the motor housing 21 may be discharged to the exterior via outlet openings 56 provided in the motor housing 21 that will be described later. Further, at the front end of this motor shaft 151, there may be provided a motor gear 152 in mesh with an output gear 42 that will be described later. In this way, the electric motor 14 accommodated in the drive main body 13 may generate the rotational drive force for rotating a motor gear 142. A handle structure may be formed on the outer peripheral surface of the drive main body 13 and will be described later.

The motor housing 21 forming the outer peripheral surface 130 of the drive main body 13 may have the inlet openings 55 and the outlet openings 56. The inlet openings 55 and the outlet openings 56 may serve to communicate between the interior and the exterior of the motor housing 21. The inlet openings 55 and the outlet openings 56 may be formed in the lower portion of the motor housing 21. By this arrangement of the inlet openings 55 and the outlet openings 56, a sufficient space may be secured for allowing arrangement of an index finger H2 and a middle finger H3 of a grasping hand H of the user at an intermediate portion 29 of the motor housing 21 as will be described later.

The inlet openings 55 may be located on the upper side of a push-in switch 63 and a direction switching lever 635 that will be described later. The inlet openings 55 may be a plurality of rectangular small holes formed in the lower portion of the motor housing 21 and arranged in parallel in the front-rear direction. On the other hand, the inlet openings 55 may be located on the lower side of the coils 165 of the stator 16. On the inner side of the inlet openings 55, there may be arranged the insulator 163 disposed at the outer periphery of the stator core 161. The insulator 163 may serve to guide the air blown by the cooling fan 185 such that the air flows through the electric motor 14 from the rear side to the front side.

In contrast, the outlet openings 56 may be arranged on the radially outer side with respect to the rotational axis of the cooling fan 185. That is, the outlet openings 56 may be formed in the exhaust direction of the cooling fan 185. More specifically, the outlet openings 56 may be formed in a lower side surface portion of the motor housing 21, i.e., the bottom side portion of the motor housing 21. By being formed in the lower side surface portion, the outlet openings 56 may be downwardly opened. This outlet openings 56 may be a plurality of small rectangular holes arranged in parallel in the left-right direction. An appropriate clearance may be set between the outlet openings 56 and the outer periphery of the cooling fan 185 so as to secure a flow passage through which air is discharged by the cooling fan 185. As described in detail later, a step portion 310 may be located on the front side of the cooling fan 185, and may provide a lower step portion 315 of a middle finger positioning portion 31.

Next, the output portion 40 will be described. The output portion 40 may serve to output the rotational drive force generated by the drive main body 13. The output portion 40 may generally include a gear drive portion 41 and a clutch portion 45. The gear drive portion 41 may include an output gear 42 and a rotation shaft 43 supporting the output gear 42. The output gear 42 may be in mesh with a motor gear 152. The output gear 42 may be arranged above and adjacent to the motor gear 152. The output gear 42 may rotate by receiving the rotational drive force from the motor gear 152. A drive side clutch portion 421 may be provided on the front surface of the output gear 42 and may be engageable with a driven side clutch portion 471 provided on a driven rotary member 47. When the drive side clutch portion 421 of the output gear 42 engages the driven side clutch portion 471 of driven rotary member 47, the output gear 42 and the driven rotary member 47 may rotate together.

The rear side of the rotation shaft 43 supporting the output gear 42 may be rotatably supported by a ball bearing 44. The front side of the rotation shaft 43 may be rotatably supported by the driven rotary member 47 of the clutch portion 45. The ball bearing 44 may be mounted to the housing 20 via a bearing retainer 19. Further, the driven rotary member 47 may be supported by a clutch housing 46 via a metal bearing 48. The clutch portion 45 functions as a so-called dog clutch or claw clutch. The clutch portion 45 may generally include the clutch housing 46, the driven rotary member 47, and a disengagement urging spring 475.

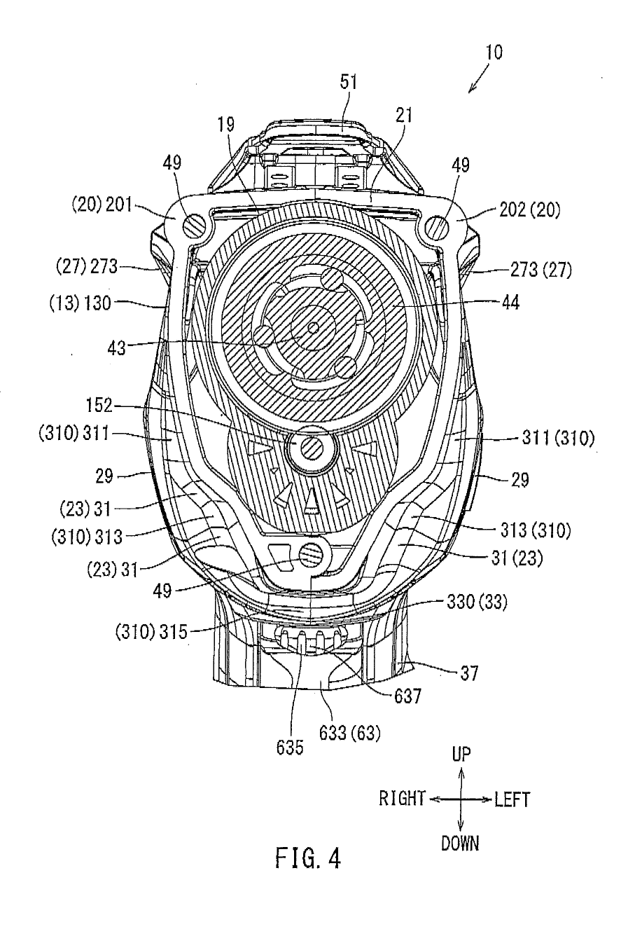

As shown in FIG. 4, the clutch housing 46 may be fixed to the housing 20 by using three screws 49. More specifically, the upper side of the clutch housing 46 may be fixed to the housing 20 by two of the screws 49 at two points, and the lower side of the clutch housing 46 may be secured to the housing 20 by the remaining one of the screws 49 at one point. These three screws 49 may be threadedly engaged with the housing 20 so as to be driven into the same from the front side toward the rear side. The lower portion of the front end of the housing 20 (motor housing 21) including the clutch housing 46 fixed thereto by the screws 49 at three points may be formed so as to become narrower as it extends downwards.

The driven rotary member 47, which can engage the drive side clutch portion 421 of the output gear 42, may be provided with a tool mounting portion 472 enabling a driver tool (driver bit) 95 to rotate together. More specifically, on the rear surface of the driven rotary member 47, there may be provided the driven side clutch portion 471 that can engage the drive side clutch portion 421 of the output gear 42. Further, at the front portion of the driven rotary member 47, there may be provided the tool mounting portion 472, with which the driver tool 95 can be fitted and engaged. A guide sleeve 501 may be disposed on the front side of the tool mounting portion 472 and may serve to guide the driver tool 95. The guide sleeve 501 may be integrated with the clutch housing 46 via a retaining sleeve 503. The driver tool 95 may be supported inside the guide sleeve 501 so as to be movable in the front-rear direction and rotatable via the metal bearing 504. The front end portion of the driver tool 95 mounted to the tool mounting portion 472 may protrudes from a front end opening 502 of the guide sleeve 501.

The disengagement urging spring 475 may be a coil spring and may apply an urging force for disengaging the engagement between the driven rotary member 47 and the output gear 42. More specifically, the disengagement urging spring 475 may urge the driven rotary member 47 forwards so as to move it away from the output gear 42. Thus, when the driven rotary member 471 is situated on the front side by the urging force of the disengagement urging spring 475, the driven rotary member 471 may not engage the drive side clutch portion 421. Hence, the driven rotary member 47 may not rotate together with the output gear 42. Therefore, the output gear 42 may rotate idle. On the other hand, when the driver tool 95 is forced rearwards against the urging force of the disengagement urging spring 475, the driven rotary member 47 may be also forced rearwards as the driver tool 95 moves rearwards. That is, with the retreat of the driver tool 95, the driven rotary member 47 also retreats. Then, the driven side clutch portion 471 of the driven rotary member 47 may engage the drive side clutch portion 421 of the output gear 42, so that the driven rotary member 47 rotates together with the output gear 42. In this way, the driver tool 95 rotates together with the driven rotary member 47 that rotates together with the output gear 42.

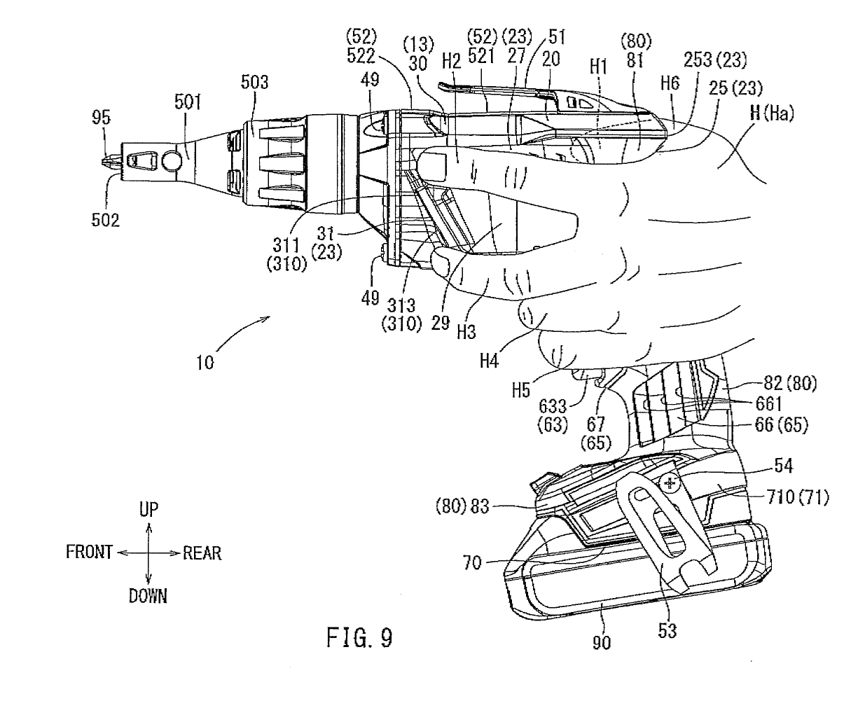

The handle 60 may extend downward from the lower portion of the drive main body 13. The handle 60 may have a shape allowing the user to grasp it. More specifically, the handle 60 may include a handle housing 61 constituting a part of the housing 20. The handle housing 61 may be provided with the push-in switch 63. This push-in switch 63 may include a switch main body 631, a trigger lever 633, and a direction switching lever 635. The switch main body 631 may be electrically connected to the controller 75. The trigger lever 633 may extend in the vertical direction so as to be vertically elongated. The trigger lever 633 may have a vertical length that is enough to allow the push-in operation (drawing operation) with the ring finger or the little finger of the user even in the case that the user grasps the drive main body 13 in a manner as shown in FIG. 9 in which the drive main body 13 is held between the thumb and the index finger from behind.

When the trigger lever 633 is operated so as to be pushed in, the push-in switch 63 is turned on, so that internal contacts (not shown) of the switch main body 631 may be connected. The switch main body 631, which is turned on, may transmit a switch ON signal to the controller 75. The direction switching lever 635 may be a lever input member for setting the rotational direction of the driver tool 95. Further, the push-in switch 63 may be provided with a lock ON button 64. The lock ON button 64 may serve to lock the switch ON state of the push-in switch 63 by pushing in the push-in switch 63 when the push-in switch 63 is in the switch ON state. By depressing the lock ON button 64 again, the lock of the switch ON state of the locked push-in switch 63 may be released. The pushing-in direction (drawing direction) of the trigger lever 633 may be set to be the rear direction, and the push-in direction of the lock ON button 64 may be set to be the right direction.

The lower enlarged portion 71 may be disposed at the lower portion of the handle housing 61. The lower enlarged portion 71 may be formed so as to enlarge a thickness of the handle 60 like the grip end of a bat. The battery attachment portion 70 may be disposed at the lower end of the lower enlarged portion 71. The battery attachment portion 70 may be configured to allow attachment and detachment of the rechargeable battery 90 as the power source. More specifically, the rechargeable battery 90 can be attached to or detached from the battery attachment portion 70 as it is slid along the battery attachment portion 70. By sliding the rechargeable battery 90 backwards from the front side, it is possible to attach the rechargeable battery 90 to the battery attachment portion 70. Conversely, by sliding the rechargeable battery 90 forwards from the rear side with respect to the battery attachment portion 70, it is possible to detach the rechargeable battery 90 from the battery attachment portion 70.

Although not shown in detail, the battery attachment portion 70 may be provided with a slide guide structure for the sliding attachment of the rechargeable battery 90. The battery attachment portion 70 may be also provided with a structure for electrical connection with the rechargeable battery 90 when the rechargeable battery 90 is attached. Further, on the upper surface of the lower enlarged portion 71, there may be provided a display device 76 that may be a liquid crystal panel or the like. The display device 76 may display various information including a remnant power of the rechargeable battery 90. Further, at the front end edge of the lower enlarge portion 71, there may be provided an LED illuminator 77. The LED illuminator 77 may be positioned so as to be capable of illuminating the forward end portion of the driver tool 95 by the LED light.

Further, though not shown in the drawings, a rotation mode input switch may be provided adjacent to the display device 76. The rotation mode input switch may be an input switch for setting the rotational speed of the driver tool 95. For example, each time the rotation mode input switch is depressed, the rotational speed of the driver tool 95 may be changed. The display device 76, the LED illuminator 77, and the rotation mode input switch may be electrically connected to the controller 75.

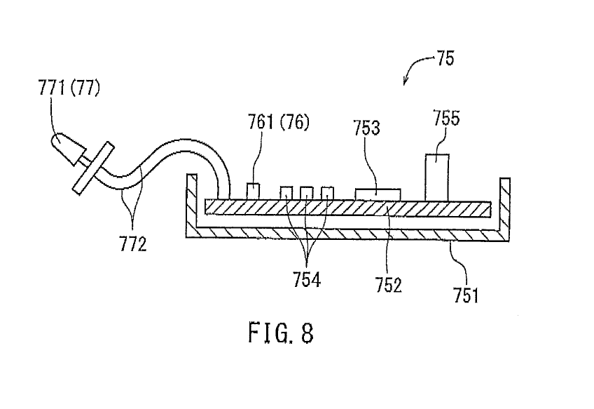

The controller 75 may be disposed within the lower enlarged portion 71. FIG. 8 is a sectional view schematically illustrating the internal structure of the controller 75. The controller 75 may be positioned on the upper side of the battery attachment portion 70. The controller 75 may control the rotational drive of the electric motor 14 may include a case 751 and a control circuit board 752 disposed within the case 751 as shown in FIG. 8. A microcomputer 753 for controlling the electric motor 14 (i.e., a brushless DC motor), and six field-effect transistors (FETs) 754 may be mounted to the control circuit board 753. Various electrical components such as a capacitor 755 may be also mounted to the control circuit board 753. The controller 75 may be electrically connected to the sensor circuit board 167 and the switch main body 631. Thus, the controller 75 can receive information transmitted from the sensor circuit board 167 and the switch main body 631. The control circuit board 752 may perform various kinds of control processing based on the received information.

The power line 166 may be connected to the controller 75 for supplying electric power to the electric motor 14 under the control of the controller 75. The controller 75 may be electrically connected to the rechargeable battery 90 attached to the battery attachment portion 70. In this way, the controller 75 can supply electric power from the rechargeable battery 90 to the electric motor 14 via the power line 166. The controller 75 may performs the control to determine the amount of electric power to be supplied to the electric motor 14 in accordance with the input at the rotation mode input switch. Further, the controller 75 can also perform control operations regarding the display of the display device 76 and the illumination of the LED illuminator 77. In this embodiment, the control circuit board 752 is provided with an LED display portion 761 of the display device 76 as show in FIG. 8. Further, the control circuit board 752 may be connected to an LED lamp 771 of the LED illuminator 77 via lead wires 772.

A body hook 51 may be disposed at the upper portion of the housing 20. The body hook 51 may allow the electric screwdriver 10 to be hooked to a waist belt or the like of the user. The body hook 51 may be connected to the housing 20 at the rear end of the upper portion of the electric screwdriver 10. The body hook 51 may be formed as a hook protruding forwards while extending slightly above the rear end of the upper portion of the housing 20. At the outer peripheral surface 130 of the drive main body 13 facing the body hook 51, there may be provided a hooking step portion 52 allowing suitable hooking to the waist belt of the user. More specifically, the hooking step portion 52 has an accommodation surface 521 allowing accommodation of a part of the waist belt or the like of the user. Further, the hooking step portion 52 may have a stepped surface 522 that can inhibit detachment of the waist belt from the space defined between the accommodation surface 521 and the body hook 51 facing to each other. The stepped surface 522 may have an outer peripheral surface configuration protruding outwards from the accommodation surface 521.

Further, a handle hook 53 may be disposed at the lower pardon of the housing 20 and may function substantially in the same manner as the body hook 51. This handle hook 53 may be formed of metal, and may be attached to the lower enlarged portion 71 of the housing 20 by screws 54. The direction in which the handle hook 53 extends is set taking into account the gravitational direction of the electric screwdriver 10. For example, when the handle hook 53 is hooked to a member for accommodating the electric screwdriver 10, the gravitational position of the electric screwdriver 10 may be positioned at a position on a vertical line extending through the handle hook 53. As a result, it is possible for the electric screwdriver 10 to be hooked in a stable manner.

The outer peripheral surface 200 of the housing 20 may be designed at least for the following purposes. That is, the configuration of the outer peripheral surface 200 of the housing 20 may be set taking into account the ease of use by the user of the electric screwdriver 10. In addition, the configuration of the outer peripheral surface 200 may be designed to provide an aesthetic appearance of the electric screwdriver 10. From these viewpoints, appropriate protrusions and recesses may be provided at the outer peripheral surface 200 of the housing 20. In addition, a molded member with a color different from the color of the housing 20 may be provided as appropriate. More specifically, hand-grip structures 23 and 37 may be provided at the outer peripheral surface 200 of the housing 20. In addition, an elastomer member 80 molded from elastomeric material may be disposed at the outer peripheral surface 200 of the housing 20. In FIG. 1, in order to make the difference between the elastomer member 80 and the outer peripheral surface 200 of the housing 20 to be easily understood, the elatomer member 80 is shown with hatching.

The elastomer member 80 may include a first elastomer member 81 disposed at the motor housing 21, a second elastomer member 82 disposed at the handle housing 61, and a third elastomer member 83 disposed at the lower enlarged portion 71. The first elastomer member 81, the second elastomer member 82 and the third elastomer member 83 may be formed in series with each other. More specifically, the first elastomer member 81, the second elastomer member 82, and the third elastomer member 83 are formed integrally so as to be connected together, enhancing the aesthetic appearance of the electric screwdriver 10.

A part of the outer peripheral surface 200 on the side of the right housing 201 and a part of the outer peripheral surface 200 on the side of the left housing 202 may be formed in a substantially symmetrical configuration. Therefore, only the part of the outer peripheral surface 200 on the side of the left housing 202 shown in FIGS. 1 through 9 will be described. FIG. 9 is a side view schematically illustrating a first grasping mode for grasping the electric screwdriver 10 of FIG. 1 by the hand of the user. In FIG. 9, a grasping hand H of the tool user is shown in a first grasping mode. The grasping hand H in the first grasping mode will be hereinafter called a grasping hand Ha.

In the drawings, of the grasping hand H, the thumb is labeled with “H1”, the index finger is labeled with “H2”, the middle finger is labeled with “H3”, the ring finger is labeled with “H4”, the littler finger is labeled with “H5”, and the finger root between the thumb and the index finger is labeled with “H6.” The first grasping structure 23 may be provided at the outer peripheral surface 130 of the drive main body 13, and the second grasping structure 37 may be provided at the outer peripheral surface 600 of the handle 60. The first grasping structure 23 may generally include a root contact recess 25, an index finger positioning portion 27, a middle finger positioning portion 31, and an auxiliary finger positioning portion 33. In the case of the grasping hand Ha shown in FIG. 9, the trigger lever 633 (push-in switch 63) may be pushed by the ring finger H4 or the little finger H5.

As shown in FIG. 1, the root contact recess 25 may be formed at the rear end portion of the outer peripheral surface 130 of the drive main body 13. The root contact recess 25 may be set as a portion that the finger root portion H6 constituting the boundary between the thumb H1 and the index finger H2 may contact in the case of the first grasping mode in which the drive main body 13 is held between the thumb H1 and the index finger H2 from behind. The root contact recess 25 may be formed so as to be concave toward the front side. In other words, the root contact recess 25 has an upper contact portion 253 having a convex shape protruding rearwards.

The root contact recess 25 further includes a lower contact portion 255 also having a convex shape protruding rearwards. The curving angle of the protruding upper end of the upper contact portion 253 may be set to be more acute than the curving angle of the protruding lower end of the lower contact portion 255. The root contact recess 25 thus formed can snugly accommodate the finger root portion H6. Further, the root contact recess 25 may include a recessed bottom portion 251 positioned between the upper contact portion 253 and the lower contact portion 255. The recessed bottom portion 251 may be set to be positioned substantially on the rotation axis of the driver tool 95 mounted to the tool mounting portion 472. Thus, when the finger root portion H6 is applied to the root contact recess 25 and pressed forwards, the force applied to the root contact recess 25 by the finger root H6 may be oriented to directly forwardly move the forward end of the driver tool 95 mounted to the tool mounting portion 472.

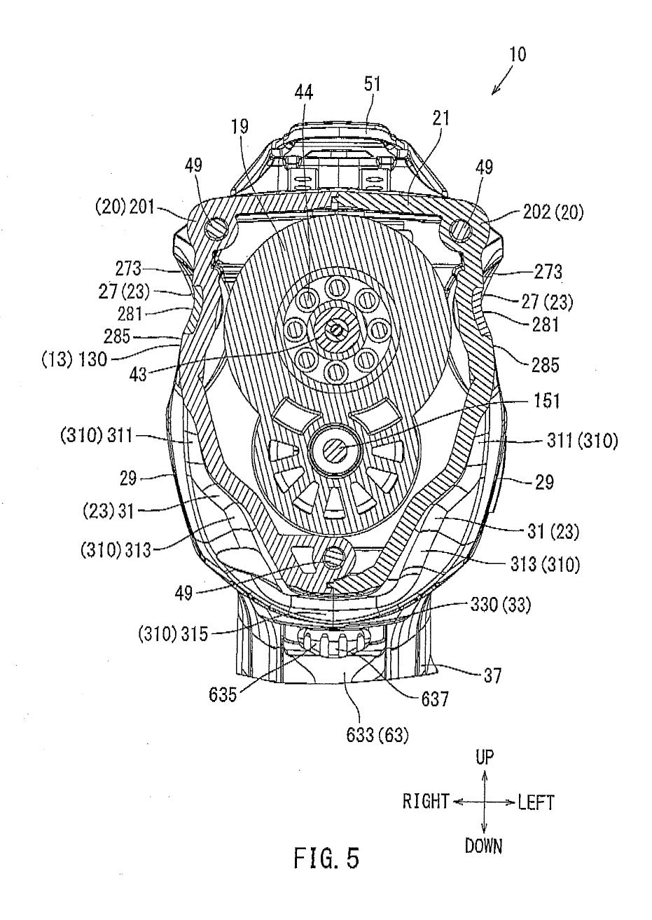

Referring to FIG. 1, the index finger positioning portion 27 may be disposed at each of the left and right side surfaces of the outer peripheral surface 130 of the drive main body 13. This index finger positioning portion 27 may be set as a portion where the thumb H1 or the index finger H2 can be positioned, with the finger root H6 being applied to the root contact recess 25. More specifically, the index finger positioning portion 27 may be formed to extend forwards from the root contact recess 25. In other words, the index finger positioning portion 27 may extend along the rotation axis of the driver tool 95 mounted to the tool mounting portion 472. As shown in FIGS. 5 through 7, the index finger positioning portion 27 may be disposed at the outer peripheral surface 130 of the drive main body 13 so as to extend forwards from the root contact recess 25. The index finger positioning portion 27 may include an upper contact portion 273 that has a convex shape and protrudes outwards. Further, the index finger positioning portion 27 may include a lower contact portion 275 that also has a convex shape and protrudes outwards.

The index finger positioning portion 27 may be concave in a direction toward the inner side of the drive main body 13 (toward the rotation axis of the driver tool 95). The nearer to the root contact recess 25 (the nearer to the rear end of the drive main body 13), the width in the vertical direction of the index finger positioning portion 27 may become larger. In other words, the farther from the root contact recess 25 (the nearer to the front end of the drive main body 13), the width of the index finger positioning portion 27 may become smaller. Further, the depth of the curved recess of the index finger positioning portion 27 may be set so as to increase in a direction toward the root contact recess 25. In other words, the curvature of the curved recess may increase in the direction toward the root contact recess 25, while the curvature may decrease so as to be flattered in a direction away from the root contact recess 25.

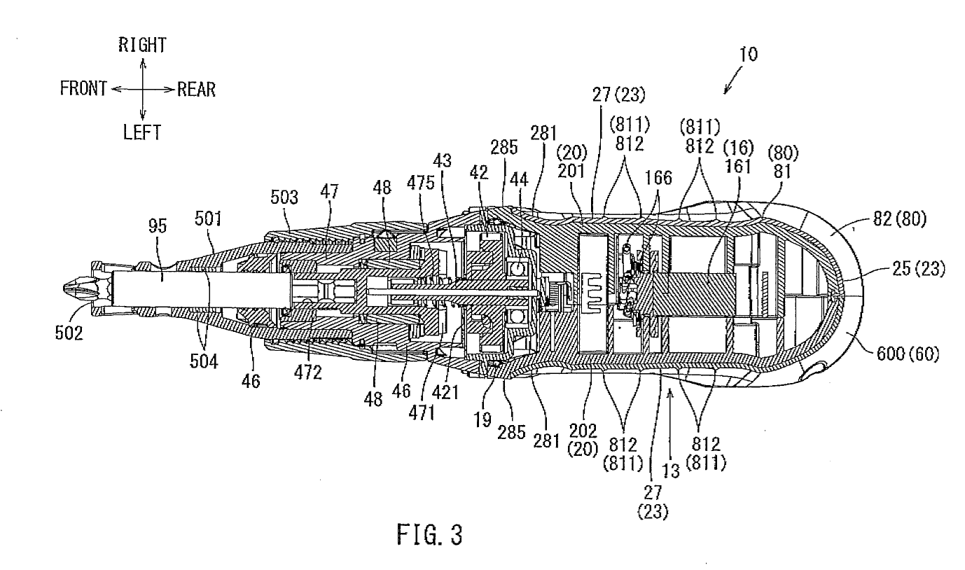

Like the vertical position of the recessed bottom portion 251 of the root abutment portion 25, the vertical position of a bottom portion 271 of the recess of the index finger positioning portion 27 may be set so as to be substantially aligned with the vertical position of the central axis of the driver tool 95 mounted to the tool mounting portion 472. Further, a front end portion 281 (see FIG. 3) of the index finger positioning portion 27 is positioned at the outer peripheral surface 130 of the drive main body 13, where the rotation shaft 43 is disposed therewithin. The front end portion 281 may be slightly recessed inwards so as to be capable of accommodating the distal end of the index finger H2. In other words, the front side portion of the front end portion 281 of the index finger positioning portion 27 is formed as a swollen portion 285 swollen slightly outwards from the index finger positioning portion 27. Therefore, when the index finger H2 is positioned at the index finger positioning portion 27, it is possible to engage the distal end of the index finger H2 with the swollen portion 285, so that the index finger H2 can be snugly accommodated.

Referring to FIG. 1, the middle finger positioning portion 31 may be also disposed at each of the left and right side surfaces of the outer peripheral surface 130 of the drive main body 130. This middle finger positioning portion 31 may be set as a portion where the middle finger H3 or the index finger H2 can be positioned, with the finger root H6 being applied to the root abutment portion 25. More specifically, the middle finger positioning portion 31 may include a step portion 310 in the front-rear direction at the front side portion of the outer peripheral surface 130. By providing the step portion 310 in the front-rear direction, the rear side pardon of the step portion 310 may protrude outwardly relative to the step portion 310. Due to recess provided by the step portion 310, the middle finger positioning portion 31 can allow the positioning of the middle finger H3 or the index finger H2 of the grasping hand H.

The middle finger positioning portion 31 may be disposed on the lower side of the index finger positioning portion 27 of the motor housing 21. The middle finger positioning portion 31 may be positioned on the front side of both the inlet openings 55 and the outlet openings 56. This middle finger positioning portion 31 may extend downwards from the front end portion 281 of the index finger positioning portion 27. The middle finger positioning portion 31 may be inclined slightly backwards as it extends downwards. Further, as shown inn FIGS. 4 and 5, the index finger positioning portion 31 may be configured to correspond to the configuration of the drive main body 13 which is tapered as it extends downwards. That is, the middle finger positioning portion 31 is inclined toward the inner side as the drive main body 113 extends downwards. Therefore, the middle finger positioning portions 31 disposed at both the left and right side surfaces may extend to gradually reduce the distance therebetween in the right-left direction as the drive main body 13 extends downwards. The lower ends of the middle finger positioning portions 31 may be connected so as to be continuous with each other.

Further, from the viewpoint regarding the position in the vertical direction, the stop portion 301 of the middle finger positioning portion 31 may be divided into a motor gear step portion 311, a tapered step portion 313, and a lower step portion 315. As shown in FIGS. 4 and 5, the motor gear step portion 311 may be disposed at a part of the outer peripheral surface 130 of the drive main body 13 (more specifically, the motor housing 21), which part is positioned proximal to a motor gear 152. Thus, the motor gear step portion 311 may be positioned on the front side with respect to the electric motor 14 and also on the front side with respect to the cooling fan 185 and the front side bearing 182. In this way, the motor gear step portion 311 can be provided by recessing the outer peripheral surface 130 of a part of the drive main body 13, in which the motor gear 152 having an outer diameter smaller than those of the cooling fan 185 and the front side bearing 182 is disposed. Therefore, the middle finger H3 or the index finger H2 of the grasping hand H can be easily positioned at the motor gear step portion 311. Further, the outer peripheral surface of the motor gear step portion 311 may be formed so as to be continuous with the outer peripheral surface of the swollen portion 285 positioned on the front side of the front end portion 281 of the index finger positioning portion 27, while the outer peripheral surface of the motor gear step portion 311 being inclined inwardly as it extends downwards.

On the other hand, as shown in FIGS. 4 and 5, the tapered step portion 313 may be disposed at a part of the outer peripheral surface 130 (more specifically, the motor housing 21) of each of the right and left side of the drive main body 13, which part is positioned proximal to a region between the motor gear 152 and the front side bearing 182. The tapered step portion 313 may be inclined backwards as it extends downwards. The lower portion of the tapered step portion 313 may be positioned at a part of the outer peripheral surface 130 of each of the right and left sides of the drive main body 13, which part is positioned proximal to the front side bearing 182. The lower step portion 315 may be formed in continuous with the lower portion of the tapered step portion 313 and may be disposed at a part of the outer peripheral surface 130 (more specifically, the motor housing 21) of the right and left sides of the drive main body 13, which part is positioned on the lower side of the front bearing 182.

The tapered step portion 313 and the lower step portion 315 may be located on the front side with respect to the electric motor 14 and the cooling fan 185. Because the outer diameter of the front side bearing 182 may be smaller than the outer diameter of the cooling fan 185, the tapered step portion 313 and the lower step portion 315 can be formed by recessing the outer peripheral surface 130 of the drive main body 13. Conversely, a part of the outer peripheral surface 130 of each of the right and left sides of the drive main body 13 positioned adjacent to the cooling fan 185 may protrude outwards in relation to the provision of the step portion 310. Therefore, it may be possible to secure a passage on the outer peripheral side of the cooling fan 185 for the flow of the cooling air generated by the cooling fan 185. The bosses 22 for the screws may be positioned on the upper side of the lower step portion 315. The middle finger H3 or the index finger H2 or the ring finger H4 of the grasping hand H can be positioned at the tapered step portion 313 and the lower step portion 315 formed as described above.

The first elastomer member 81 may be disposed only at the root contact recess 25 and the index finger positioning portion 27 of the outer peripheral surface 130 of the drive main body 13. Therefore, the first elastomer member 81 disposed at the root contact recess 25 and the index finger positioning portion 27 can be used as a reference mark for positioning the grasping hand H as shown in FIG. 9. Further, when the hand H is positioned at the root contact recess 25 and the index finger positioning portion 27, a soft touch feel may be given due to the softness of the elastomer.

Further, the first elastomer member 81 disposed at the index finger positioning portion 27 may include four slip preventing portions 811 arranged in parallel in the front-rear direction. The slip preventing portions 811 may be configured as recesses each having a substantially U-shape with its rear side portion 812 (a closed bottom side portion of the U-shape) located on the rear side. The rear side portion 812 of each of the slip preventing portions 811 may extend in the vertical direction. Therefore, as the pad of the index finger H2 is positioned at the slip preventing portions 811, the pad may be first enlarged in its contact range in the vertical direction before engagement with the rear side portion 812. As a result, the contact range of the index finger H2 may be enlarged, and therefore, the touch feel of the finger can be improved. On the other hand, a part of the outer peripheral surface 130 at the motor housing 21 of the drive main body 13 located on the lower side of the index finger positioning portion 27 may be directly exposed to the exterior. Therefore, the user of the tool can freely position the middle finger H3, the ring finger H4, etc.

The auxiliary finger positioning portion 33 may be disposed at a portion of the outer peripheral surface 130 (more specifically, the motor housing 21) of the drive main body 13 for allowing positioning of the middle finger H3 or the ring finger H4 of the grasping hand H. This auxiliary finger positioning portion 33 may be positioned at the lower portion of the motor housing 21 within a region between the inlet openings 55 and the outlet openings 56. In addition, the auxiliary finger positioning portion 33 may be positioned on the upper side of the direction switching lever 635 and proximal to the direction switching lever 635.

The auxiliary finger positioning portion 33 may be a recess formed at the lowermost portion (bottom portion) of the outer peripheral surface 130 (more specifically, the motor housing 21) of the drive main body 13 and may be recessed gently upwards as it extends forwards. More specifically, the auxiliary finger positioning portion 33 may include an auxiliary step portion 330 recessed upwardly as it extends forwards. Therefore, the auxiliary finger positioning portion 33 can suitably engage the middle finger H3 or the ring finger H4 of the grasping hand H. In other words, the auxiliary step portion 330 protrudes downwards as it extends rearwards for engagement with the middle finger H3 or the ring finger H4 of the grasping hand H. The outer peripheral surface of the auxiliary step portion 330 may be substantially flush with a front surface 637 of the direction switching lever 635.

In contrast to the first hand grip structure 23, the second hand grip structure 37 may be disposed at the outer peripheral surface 600 of the handle 60. The second hand grip structure 37 may have a shape like a generally used pistol-shaped grip. The handle housing 61 of the handle 60 may be is provided with the second elastomer member 82 as described previously. The second elastomer member 82 may cover substantially the entire outer peripheral surface 610 of the handle housing 61 except for some regions. More specifically, a region of the outer peripheral surface 610 around the push-in switch 63 and a region where the lock ON button 64 is arranged may not be covered with the second elastomer member 82.

The third elastomer member 83 may be disposed at the lower enlarged portion 71. The region of the lower enlarged portion 71 covered with third elastomer member 83 may be appropriately determined, for example, by taking into account of an aesthetic design. The second elastomer member 82 may have a Emotion of improving the grip performance of the handle 60. On the other hand, the third elastomer member 83 may have a function of suppressing damage of the lower enlarged portion 71, which may be caused due to collision.

At the lower portion of the handle housing 61, there may be provided a little finger grip structure 65. The little finger grip structure 65 may enhance the grip force of the little finger H5 and the ring finger H4. More specifically, the little finger grip structure 65 may include a side surface step portion 66 and an upper diameter-enlarged portion 67. The side surface step portion 66 may include a plurality of steps 661 each extending along a line in the vertical direction of the handle housing 61. Therefore, each of the steps 661 may extend in a direction crossing the directions along which the little finger H5 and the ring finger H4 may extend. In this way, the little finger H5 and the ring finger H4 can be easily engaged with and caught by the steps 661 when they move backwards. Therefore, the grip force can be enhanced. The upper diameter-enlarged portion 67 may have a shape protruding forwards as it extends upwards. Thus, the little finger H5 and the ring finger H4 can be easily engaged and caught by the upper diameter-enlarged portion 67 when they are move upwards.

With the electric screwdriver 10 according to this embodiment, it is possible to achieve the following advantages. That is, the middle finger positioning portion 31 is disposed at the outer peripheral surface 130 of the drive main body 13 of the electric screwdriver 10 and is recessed so as to allow positioning of the middle finger H3. Due to the recessed shape of the middle finger positioning portion 31, it is possible to achieve an improvement in finger engaging ability for the middle finger H3 when the middle finger H3 is positioned at the middle finger positioning portion 31. As a result, it is possible to firmly grasp the electric screwdriver 10 with the grasping hand H when the user pulls back the electric screwdriver 10 after stopping the pressing of the electric screwdriver 10 against the workpiece.

Further, the index finger positioning portion 27 is disposed at the outer peripheral surface 130 of the drive main body 13 and is recessed so as to allow positioning of the index finger H2 when the user grasps the electric screwdriver 10 with his hand H as described above. Therefore, due to the recessed shape of the index finger positioning portion 27, it is possible to achieve an improvement in terms of finger engaging ability for the index finger H2 when the index finger H2 is positioned at the index finger positioning portion 27. As a result, also in this respect, it is possible to firmly grasp the electric screwdriver 10 with the grasping hand H when the user pulls back the electric screwdriver 10 after stopping the pressing of the electric screwdriver 10 against the workpiece.

Further, the auxiliary finger positioning portion 33 is disposed at the outer peripheral surface 130 of the drive main body 113 and is recessed so as to allow positioning of the middle finger H3 or the ring finger H4 when the user grasps the electric screwdriver 10 with his hand H as described above. Therefore, due to the recessed shape of the auxiliary finger positioning portion 33, it is possible to achieve an improvement in terms of finger engaging ability for the middle finger H3 or the ring finger H4 when the middle finger H3 or the ring finger H4 is positioned at the auxiliary finger positioning portion 33. As a result, also in this respect, it is possible to firmly grasp the electric screwdriver 10 with the grasping hand H when the user pulls back the electric screwdriver 10 after stopping the pressing of the electric screwdriver 10 against the workpiece.

Further, in the electric screwdriver 10 described above, the inlet openings 55 and the outlet openings 56 are disposed at the lower portion of the motor housing 21. It may be preferable that the fingers of the user do not contact the region where the inlet openings 55 and the outlet openings 56 are disposed. Therefore, by disposing the inlet openings 55 and the outlet openings 56 at the lower portion of the motor housing 31, it may be possible to use an intermediate portion 29 as a portion where the fingers may contact. As a result, the intermediate portion 29 may have a large area at each of the left and right the sides of the motor housing 21, making it possible to enhance the degree of freedom in terms of positioning of the middle finger 31, the index finger positioning portion 27, and the auxiliary finger positioning portion 33. Thus, it is possible to enhance the ease of handling of the electric screwdriver 10 and to improve the design of the electric screwdriver 10.

Further, in the above electric screwdriver 10, the middle finger positioning portion 31 is positioned on the front side of the inlet openings 55 and the outlet openings 56. Therefore, it is possible to appropriately position the middle finger positioning portion 31 while securing the communication of air through the inlet openings 55 and the outlet openings 56. As a result, it is possible to appropriately position the middle finger positioning portion 31 without adversely affect the function of the electric screwdriver 10.

Further, in the above electric screwdriver 10, the auxiliary finger positioning portion 33 is disposed at a position between the inlet openings 55 and the outlet openings 56. Therefore, it is possible to appropriately position the auxiliary finger positioning portion 33 while securing the communication of air through the inlet openings 55 and the outlet openings 56. As a result, it is possible to appropriately position the auxiliary finger positioning portion 33 for allowing positioning of the middle finger H3 or the ring finger H4 without adversely affect the function of the electric screwdriver 10. In the case of the grasping hand Ha shown in FIG. 9, the trigger lever 633 of the push-in switch 63 can be pushed by the ring finger H4 and the little finger H5.

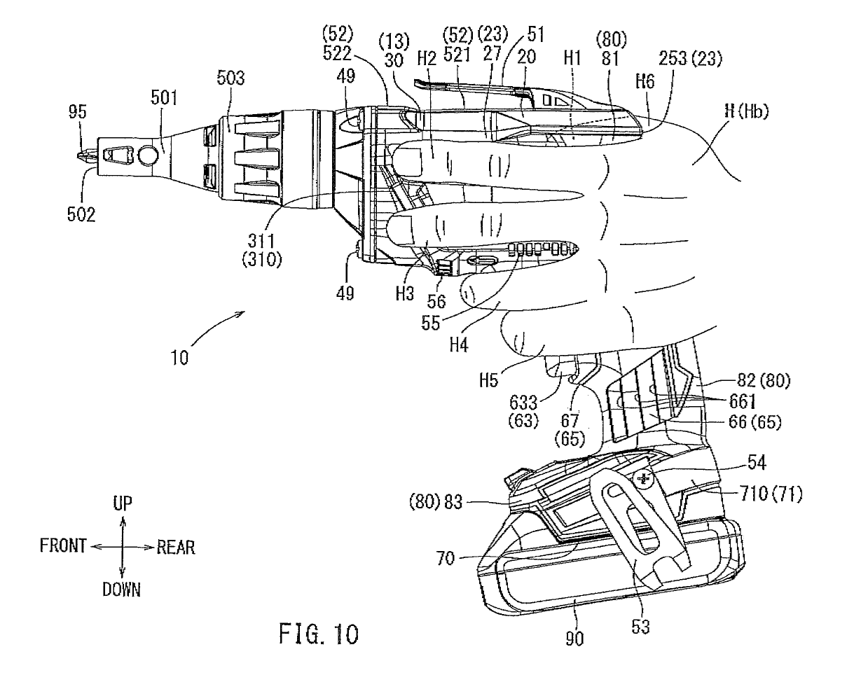

Other than the first grasping mode by the grasping hand Ha, the electric screwdriver 10 described above may allow various grasping modes. FIG. 10 is a side view schematically showing a second grasping mode by a grasping hand Hb. In the first grasping mode by the grasping hand Ha described above, the middle finger H3 may be positioned at and engaged with the lower step portion 315 of the middle finger positioning portion 31. In the second grasping mode, the middle finger H3 of the grasping hand Hb may be positioned at and engaged with the tapered step portion 313 of the middle finger positioning portion 31. Further, in this second grasping mode, it is assured that the ring finger 114 is positioned at and engaged with the auxiliary finger positioning portion 33. In this case, the trigger lever 633 of the push-in switch 63 may be pushed solely by the little finger H5.

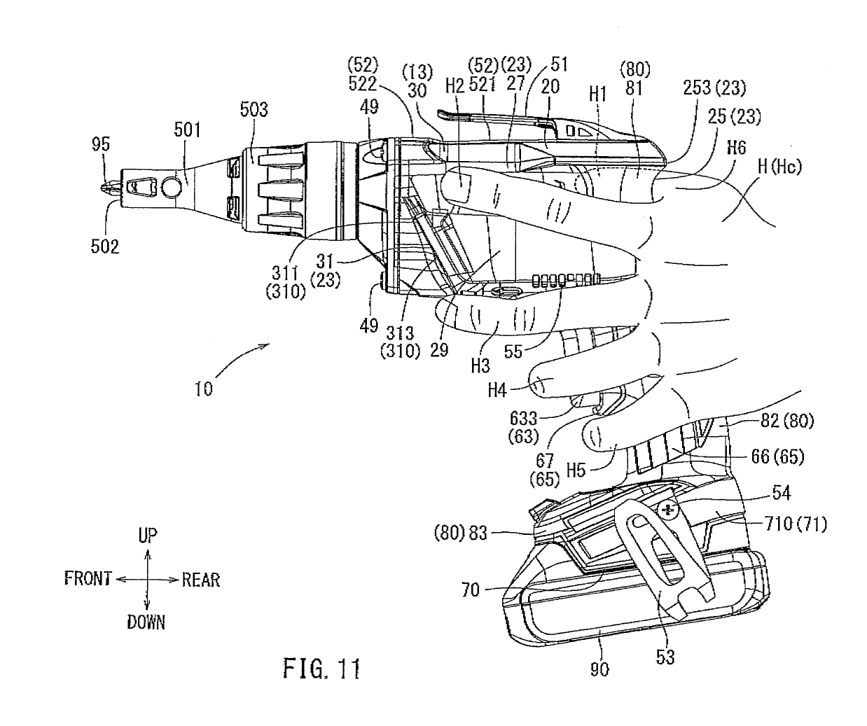

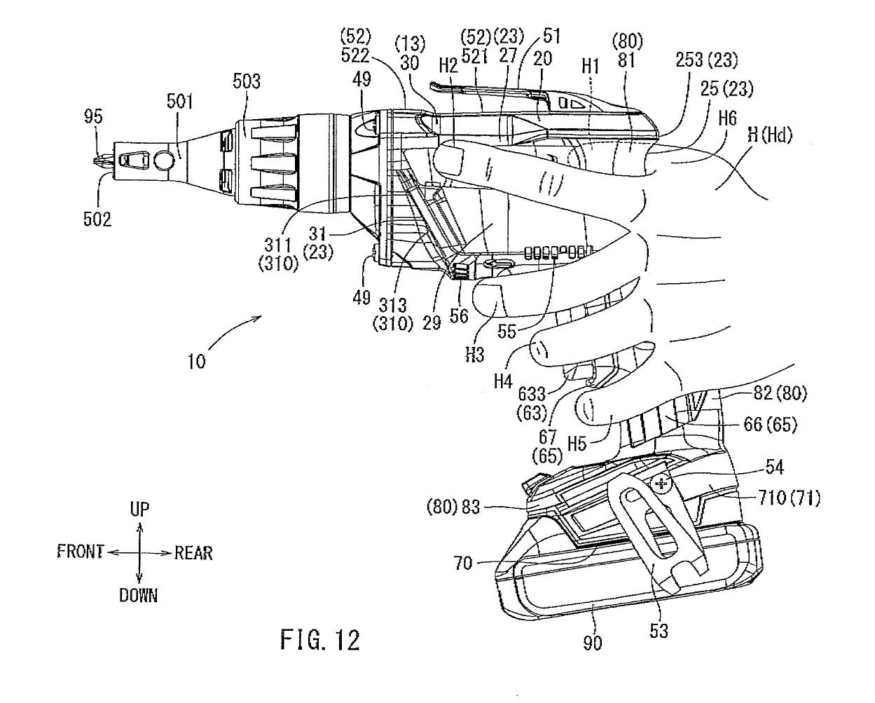

FIG. 11 is a side view schematically illustrating a third grasping mode by a grasping hand Hc. In the first grasping mode described above, the little finger H5 can push the trigger lever 633 of the push-in switch 63 together with the ring finger H4. In the third grasping mode, the little finger H5 may be positioned at and engaged with the little finger grip structure 65. Therefore, the trigger lever 63 of the push-in switch 63 may be pushed solely by the ring finger H4. FIG. 12 is a side view schematically illustrating a fourth grasping mode by a grasping hand Hd. In the third grasping mode described above, the middle finger H3 may be positioned at and engaged with the lower step portion 315 of the middle finger positioning portion 31. In the fourth grasping mode, the middle finger H3 of the grasping hand Hd may be positioned at and engaged with the auxiliary finger positioning portion 33. Also in this fourth grasping mode, the trigger lever 633 of the push-in switch 63 may be pushed solely by the ring finger H4.

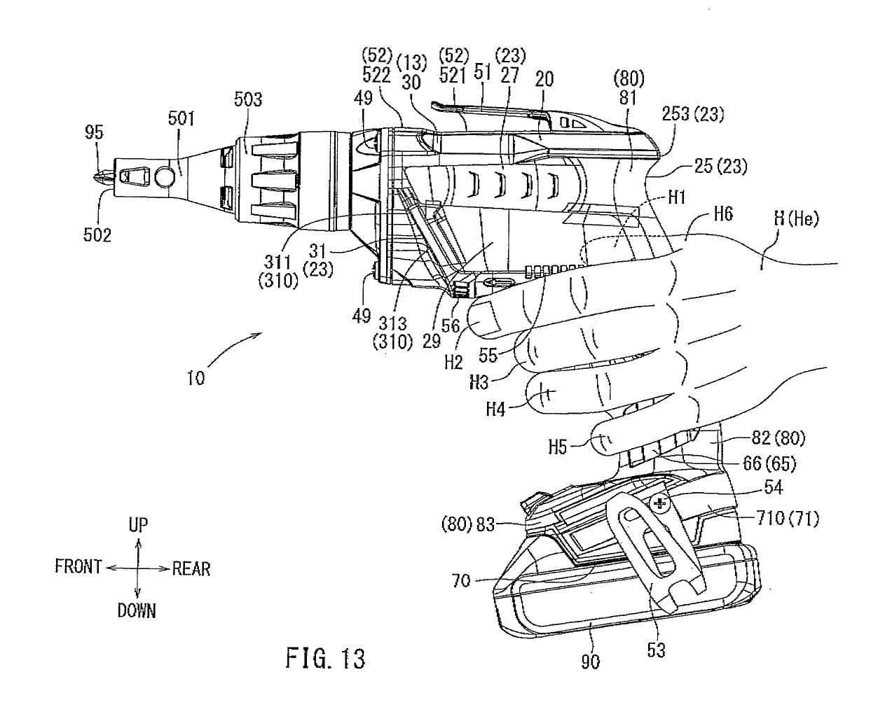

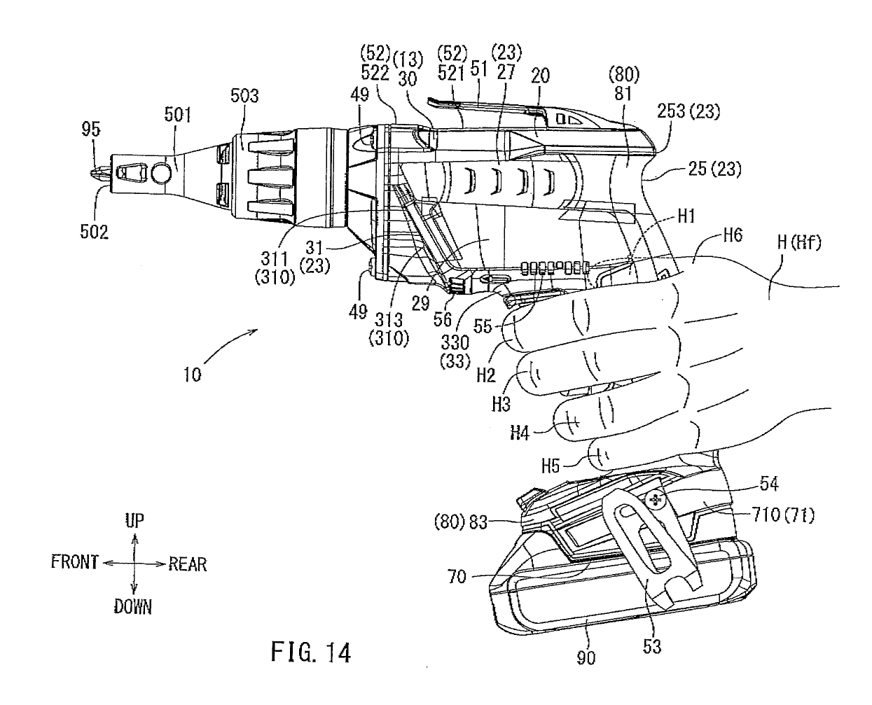

FIG. 13 is a side view schematically illustrating a fifth grasping mode by a grasping hand He. FIG. 14 is a side view schematically illustrating a sixth grasping mode by a grasping hand Hf. The fifth grasping mode and the sixth grasping mode may be different from the first through fourth grasping modes by the grasping hands Ha, Hb, He, and Hd. In the first through fourth grasping modes, the drive main body 13 may be held between the thumb H1 and the index finger 112 from behind, so that the finger root portion H6 may contact the root contact recess 25. Therefore, the first through fourth grasping modes may be collectively called a body grasping mode. In contrast, in the fifth and sixth grasping modes, the handle 60 may be grasped while the finger root portion H6 does not contact the root contact recess 25. Therefore, the fifth and sixth grasping modes may be collectively called a handle grasping mode.

More specifically, in the fifth grasping mode by the grasping hand He, the handle 60 is held between the thumb H1 and the index finger H2 from behind, and the finger root portion H6 positioned between the thumb H1 and the index finger H2 may contact the rear portion of the handle 60. Thus, in this grasping mode, the index finger H2 may be positioned at and engaged with the auxiliary finger positioning portion 33. Further, the trigger lever 633 of the push-in switch 63 may be pushed by the middle finger H3 and the ring finger H4. Furthermore, in this fifth grasping mode, the little finger H5 may be positioned at and engaged with the little finger grip structure 65. More specifically, the little finger H5 may be positioned mainly at the side step portion 66 of the little finger grip structure 65.

Also in the sixth grasping mode by the grasping hand Hf, the handle 60 may be held between the thumb H1 and the index finger H2 from behind, and the finger root H6 positioned between the thumb H1 and the index finger H2 may contact the rear portion of the handle 60. In the sixth grasping mode, the trigger lever 633 of the push-in switch 63 may be pushed by the index finger H2 and the middle finger H3. Further, in the sixth grasping mode, the ring finger H4 and the little finger H5 may be positioned at and engaged with the little finger grip structure 65. The ring finger H4 may be positioned at and engaged with the side step portion 66 and the upper diameter-enlarged portion 67 of the little finger grip structure 65. The little finger H5 may be positioned mainly at the side step portion 66 of the little finger grip structure 65.

Although the above representative embodiment has been described in connection with the electric screwdriver 10, the above teachings may be applied to any other electric tools. For example, the above teachings may be applied to an electric hammer drill, an electric driver drill or any other tools so long as they have a handle extending downwards from a lower portion of a drive main body accommodating an electric motor. Further, regarding the recessed configurations of the index finger positioning portion, the middle finger positioning portion, and the auxiliary finger positioning portion, they may be suitably changes from those described in the above representative embodiment.

Representative, non-limiting examples were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electric tools, and methods of making and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. An electric tool comprising:
a drive main body configured to accommodating an electric motor that generates a drive force;
an output portion disposed on a front side of the drive main body and configured to output the drive force;
a handle extending downwards from a lower portion of the drive main body;
a middle finger positioning portion disposed at an outer peripheral surface of the drive main body and includes a recessed structure to allow positioning of a middle finger of a hand of a user when the user grasps the drive main body in a body grasping mode, in which the drive main body is held between a thumb and an index finger of the hand from behind.

2. The electric tool according to claim 1, further comprising an index finger positioning portion disposed at the outer peripheral surface of the drive main body and includes a recessed structure to allow positioning of the index finger when the user grasps the drive main body in the body grasping mode.

3. The electric tool according to claim 1, further comprising an auxiliary finger positioning portion disposed at the outer peripheral surface of the drive main body and includes a recessed structure to allow positioning of the middle finger or a ring finger of the hand when the user grasps the drive main body in the body grasping mode.

4. The electric tool according to claim 1, wherein:
the drive main body includes a body housing having the outer peripheral surface;
the electric tool further comprises at least one inlet opening and at least one outlet opening formed in the body housing and configured to allow communication between inside and outside of the body housing, so that air can flow into the body housing via the at least one outlet opening and can flow to the outside via the at least one outlet opening;
the at least one inlet opening and the at least one outlet opening are disposed at a lower portion of the body housing.

5. The electric tool according to claim 4, wherein:
the middle finger positioning portion is disposed on a front side of both of the at least one inlet opening and the at least one outlet opening.

6. The electric tool according to claim 3, wherein:
the drive main body includes a body housing having the outer peripheral surface;
at least one inlet opening and at least one outlet opening formed in the body housing and configured to allow communication between inside and outside of the body housing, so that air can flow into the body housing via the at least one outlet opening and can flow to the outside via the at least one outlet opening;
the at least one inlet opening and the at least one outlet opening are disposed at a lower portion of the body housing.

7. The electric tool according to claim 6, wherein:
the auxiliary finger positioning portion is disposed between the at least one inlet opening and the at least one outlet opening.

8. The electric tool according to claim 1, further comprising a trigger lever disposed at the handle and arranged such that the user can pull the trigger lever by at least a little finger of the hand when the user grasps the drive main body in the body grasping mode.

9. The electric tool according to claim 1, further comprising a little finger engaging structure disposed at an outer peripheral surface of the handle and includes a recessed structure to allow positioning of at least a little finger of the hand when the user grasps the handle in a handle grasping mode in which the handle is held between the thumb and the index finger of the hand from behind.

10. An electric tool comprising:
a drive main body configured to accommodating an electric motor that generates a drive force;
an output portion disposed on a front side of the drive main body and configured to output the drive force;
a handle extending downwards from a lower portion of the drive main body;
a first hand-pip structure disposed at an outer peripheral surface of the drive main body;
a second hand-grip structure disposed at an outer peripheral surface of the handle;
a trigger lever disposed at the handle;
the first and second hand-grip structures and the trigger lever are arranged such that;
(a) when a user grasps the drive main body in a body grasping mode in which the drive main body is held between a thumb and an index finger of the hand from behind, the index finger and a middle finger of the hand engage the first hand-grip structure, while at least one of a ring finger and a little finger of the hand being engaged with the trigger lever; and
(b) when the user grasps the handle in a handle grasping mode in which the handle is held between the thumb and the index finger of the hand from behind, the little finger engages the second hand-grip structure while the middle finger being engaged with the trigger lever.

11. An electric tool comprising:
a drive main body configured to accommodating an electric motor;
an output portion disposed on a front side of the drive main body and configured to be driven by the electric motor;
a handle extending downwards from a lower portion of the drive main body;
a left side elastomer member and a right side elastomer member respectively disposed at a left side portion and a right side portion of an outer peripheral surface of the chive main body and extending in a front-rear direction;
a step portion disposed at the outer peripheral surface of the drive main body at a position on the lower side of at least one of the left side and right side elastomer members.

12. The electric tool according to claim 11, further comprising at least one air outlet opening formed in the outer peripheral surface of the drive main body, wherein the at least one outlet opening is disposed on a rear side of the step portion.

13. The electric tool according to claim 11, further comprising at least one air inlet opening and at least one air outlet opening formed in the outer peripheral surface of the drive main body, wherein the at least one air inlet opening and the at least one air outlet opening are disposed on a lower side of the left and right side elastomer members.
